(19) United States
(12) Patent Application Publication
(10) Pub. No.: US 2020/0342169 A1
(43) Pub. Date: Oct. 29, 2020

(54) INFORMATION PROCESSING APPARATUS AND NON-TRANSITORY COMPUTER READABLE MEDIUM STORING PROGRAM

(71) Applicant: FUJI XEROX CO., LTD., Tokyo (JP)

(72) Inventors: Junichi SHIMIZU, Kanagawa (JP); Kunihiko KOBAYASHI, Kanagawa (JP); Daigo HORIE, Kanagawa (JP)

(73) Assignee: FUJI XEROX CO., LTD., Tokyo (JP)

(21) Appl. No.: 16/721,951

(22) Filed: Dec. 20, 2019

(30) Foreign Application Priority Data
Apr. 26, 2019 (JP) 2019-086033

(51) Int. Cl. G06F 40/268; G06F 40/279; G06K 9/20; G06K 9/00

(52) U.S. Cl. CPC G06F 40/268; G06K 9/00456; G06K 9/2063; G06F 40/279

(57) ABSTRACT

An information processing apparatus includes a storage unit that stores a first keyword obtained by combining a plurality of words, an extraction unit that extracts a text string indicating a value corresponding to the first keyword, from a result of text recognition on a document image, a detection unit that detects an identical or similar word, as a reference word being a reference of a combination, from a plurality of words included in the first keyword and a second keyword in response to reception of an instruction to newly register the second keyword having a meaning which is not identical but similar to a meaning of the first keyword, and an output unit that outputs a new third keyword obtained by combining the reference word and at least one of a first target word or a second target word while maintaining a context with the reference word, the first target word being connected before or after the reference word in the first keyword, and being a target of a combination, the second target word being connected before or after the second keyword, and being a target of the combination.

### CROSS-REFERENCE TO RELATED APPLICATIONS

This application is based on and claims priority under 35 USC 119 from Japanese Patent Application No. 2019-086033 filed Apr. 26, 2019.

### BACKGROUND

### (i) Technical Field

The present invention relates to an information processing apparatus and a non-transitory computer readable medium storing a program.

### (ii) Related Art

JP2018-128996A discloses an information processing apparatus including an extraction section that extracts a region by performing region analysis processing on an image, acquisition section that acquires a rule for extracting a specific keyword and a value corresponding to the keyword, a determination section that determines an order for specifying the region including the keyword and the region including the value corresponding to the keyword by using the rule, in accordance with values allowed to be taken by the keyword and the value corresponding to the keyword included in the rule, a specifying section that specifies the region including the keyword or the region including the value corresponding to the keyword from the extracted region in accordance with the determined order, and a text recognition section that performs text recognition processing on the specified region. The specifying section specifies the other corresponding region based on the previously-specified region, in accordance with the determined order.

### SUMMARY

Aspects of non-limiting embodiments of the present disclosure relate to an information processing apparatus and a non-transitory computer readable medium storing a program in which, in a system that extracts a value corresponding to a registered keyword from a result of text recognition on a document image, in a case where the registered keyword is a combination of a plurality of words, it is possible to reduce a labor in a case where a user registers a plurality of new keywords having a meaning which is identical or similar to the meaning of the registered keyword.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing apparatus including a storage unit that stores a first keyword obtained by combining a plurality of words, an extraction unit that extracts a text string indicating a value corresponding to the first keyword, from a result of text recognition on a document image, a detection unit that detects an identical or similar word, as a reference word being a reference of a combination, from a plurality of words included in the first keyword and a second keyword in response to reception of an instruction to newly register the second keyword having a meaning which is not identical but similar to a meaning of the first keyword, and an output unit that outputs a new third keyword obtained by combining the reference word and at least one of a first target word or a second target word while maintaining a context with the reference word, the first target word being connected before or after the reference word in the first keyword, and being a target of a combination, the second target word being connected before or after the second keyword, and being a target of the combination.

### BRIEF DESCRIPTION OF THE DRAWINGS

Exemplary embodiment(s) of the present invention will be described in detail based on the following figures, wherein:

FIG. 1 is a schematic diagram illustrating an example of a document as a processing target;

FIG. 2 is a block diagram illustrating an example of an electrical configuration of an information processing apparatus according to an exemplary embodiment of the invention;

FIG. 3 is a chart illustrating an example of a management table;

FIG. 4 is a block diagram illustrating an example of a functional configuration of the information processing apparatus according to the exemplary embodiment of the invention;

FIG. 5 is a flowchart illustrating an example of a flow of “value extraction processing”;

FIG. 6 is a flowchart illustrating an example of a flow of “keyword addition processing”;

FIG. 7 is a flowchart illustrating an example of a flow of “keyword generation processing”;

FIG. 8 is a schematic diagram illustrating an example of a reception screen;

FIG. 9 is a schematic diagram illustrating an example of a result confirmation screen;

FIG. 10 is a schematic diagram illustrating an example of a keyword addition screen;

FIG. 11 is a schematic diagram illustrating an example of a generation result display screen;

FIG. 12 is a schematic diagram illustrating an example of a re-extraction screen;

FIG. 13 is a diagram illustrating a form in which directed graphs representing keywords are integrated;

FIG. 14 is a diagram illustrating the form in which directed graphs representing keywords are integrated; and

FIG. 15 is a diagram illustrating the form in which directed graphs representing keywords are integrated.

### DETAILED DESCRIPTION

Hereinafter, an example of an exemplary embodiment of the present invention will be described in detail with reference to the accompanying drawings.

Value Extraction Processing

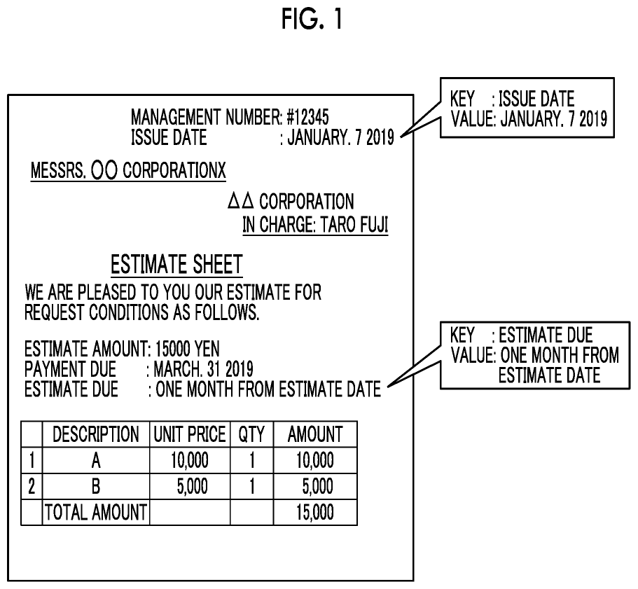

Firstly, a document used as a processing target in the exemplary embodiment will be described. FIG. 1 is a schematic diagram illustrating an example of a document as a processing target. A document as the processing target includes an item and a value corresponding to the item. For example, in a form such as an estimate sheet, a value corresponding to each item is described. A case where the document is an estimate sheet will be described below.

As illustrated in FIG. 1, in the estimate sheet, a management number, an issue date, an estimate amount, a payment due, an estimate due, a description, unit price, a quantity, an amount, and the like are provided as items. For example, for the item of “issue date”, a value of “Jan. 7, 2019” is described. For the item of “estimate due”, a value of “one month from the estimate date” is described.

The estimate sheet is used as an original document, and an image of the estimate sheet is read. On the page of the read image, an image representing a value corresponding to an item is disposed in the vicinity of an image representing the item. In a case of performing text recognition on the read image, text recognition is performed on each image in the page. A result of the text recognition includes a position of an image representing an item in the page, a text string representing the item, a position of an image representing a value in the page, and a text string representing the value. The position in the page may be indicated by position coordinates with a predetermined point as an origin.

Item and Value

A text string representing an item and a text string representing a value corresponding to the item are associated with each other by each position in the page. A text string representing an item is designated, and text recognition is performed. A text string representing the corresponding value is extracted from the result of the text recognition. The text string representing an item is simply referred to as “a keyword” below. A text string representing a value is simply referred to as “a value”. An operation of designating a keyword and extracting a value is referred to as “value extraction processing”.

For example, in the example illustrated in FIG. 1, as a result of value extraction processing, a value of “Jan. 7, 2019” is extracted for a keyword of “issue date”. A value of “one month from the estimate date” is extracted for a keyword of “estimate due”.

Information Processing Apparatus

Next, a hardware configuration of an information processing apparatus will be described.

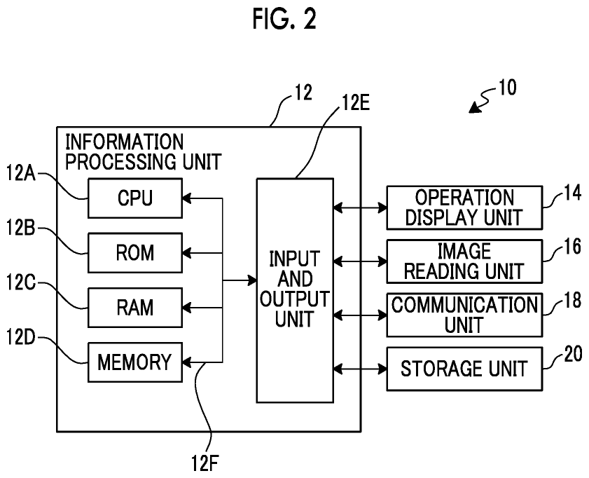

FIG. 2 is a block diagram illustrating an example of an electrical configuration of the information processing apparatus according to an exemplary embodiment of the invention. As illustrated in FIG. 2, an information processing apparatus 10 includes an information processing unit 12 being a computer that controls the connected units and performs various arithmetic operations. That is, the information processing unit 12 includes a central processing unit (CPU) 12A, a read only memory (ROM) 12B, a random access memory (RAM) 12C, a nonvolatile memory 12D, and an input and output unit (I/O) 12E.

The CPU 12A, the ROM 12B, the RAM 12C, the memory 12D, and the I/O 12E are connected to each other via a bus 12F. The CPU 12A reads a program stored in a storage device such as the ROM 12B and executes the program using the RAM 12C as a work area.

The information processing apparatus 10 includes, for example, an operation display unit 14, an image reading unit 16, a communication unit 18, and a storage unit 20. Each of the operation display unit 14, the image reading unit 16, the communication unit 18, and the storage unit 20 is connected to the I/O 12E of the information processing unit 12.

The operation display unit 14 refers to a user interface that displays various screens for a user and receives an operation from the user. For example, the operation display unit 14 includes a touch panel. The image reading unit 16 reads an image of a set original document. The communication unit 18 refers to an interface for communicating with an external device via a wired or wireless communication line. The storage unit 20 refers to an external storage device such as a hard disk.

Various programs or various types of data are stored in a storage device such as the ROM 12B. A storage area of the program is not limited to the ROM 12B. The various programs may be stored in another storage device such as the memory 12D or the storage unit 20 or may be acquired from an external device through the communication unit 18.

Various drives may be connected to the information processing unit 12. The various drives refer to devices that read data from a computer-readable portable recording medium such as a CD-ROM or a universal serial bus (USB) memory, and write data to the recording medium. In a case including various drives, the program may be executed in a manner of being recorded in a portable recording medium, and being read by the corresponding drive.

In the exemplary embodiment, a control program of value extraction processing described later is stored in the ROM 12B, and a management table and the like for managing a keyword are stored in the storage unit 20.

In the exemplary embodiment, various screens are displayed in the operation display unit 14, and the various screens are operated by the user. For example, a reception screen described later is operated to designate the type of document and a keyword and to perform an instruction to perform value extraction processing. With the image reading unit 16, an image of the estimate sheet is read to acquire image information of the estimate sheet.

Management Table

Next, a management table for managing a keyword will be described.

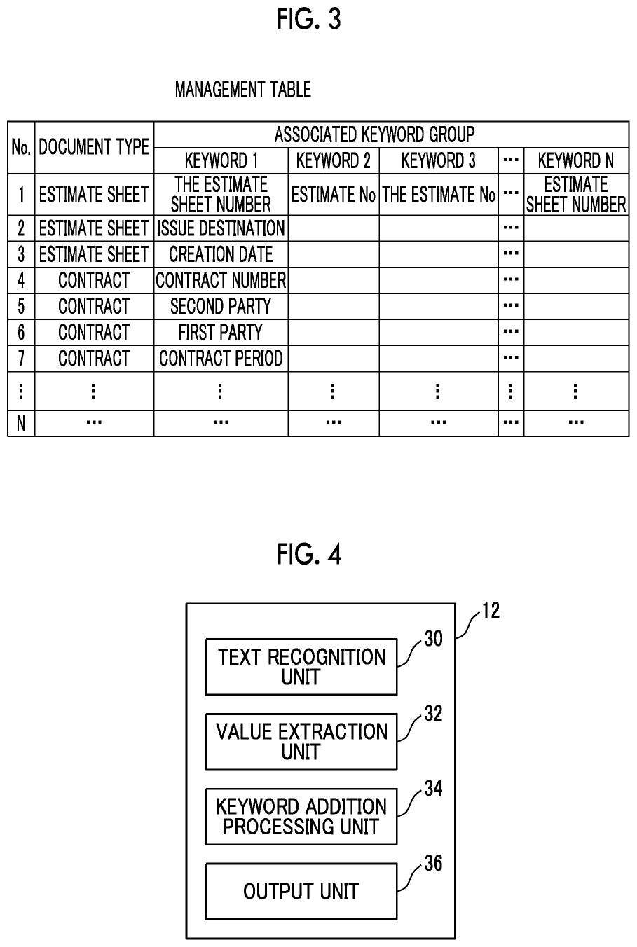

FIG. 3 is a chart illustrating an example of the management table. As illustrated in FIG. 3, keywords are collected for each keyword group to be associated (referred to as “an associated keyword group” below) and are stored in a form of the management table. A reference number is assigned to each associated keyword group, as identification information for identifying the associated keyword group. A reference number, a document type, and a correspondence relationship of an associated keyword group are stored in the management table for each associated keyword group.

In the associated keyword group, at least one keyword may be provided. Here, association of keywords with each other means that the words have not the identical but similar meanings. For example, a first associated keyword group includes keywords of “the estimate sheet number”, “estimate No”, “the estimate No”, and “estimate sheet number”. Each of the keywords includes the identical or similar word such as “estimate”, “estimate”, and “the estimate” and thus, the keywords have not the identical but similar meanings.

A keyword registered by a user and a keyword automatically generated from the registered keyword are included in the associated keyword group. As will be described later, “the estimate sheet number” and “estimate No” are the registered keywords. “The estimate No” and “estimate sheet number” are the automatically-generated keywords.

Functional Configuration

Next, a functional configuration of the information processing apparatus will be described.

FIG. 4 is a block diagram illustrating an example of the functional configuration of the information processing apparatus according to the exemplary embodiment of the invention. As illustrated in FIG. 4, the information processing apparatus 10 includes a text recognition unit 30, a value extraction unit 32, a keyword addition processing unit 34, and an output unit 36.

The text recognition unit 30 acquires image information from the image reading unit and performs text recognition on the read image.

The value extraction unit 32 acquires a designated keyword from the operation display unit. The value extraction unit 32 acquires all keywords in an associated keyword group to which the designated keyword belongs, from the management table. The value extraction unit 32 performs value extraction processing of extracting a value corresponding to the keyword, on each keyword in the associated keyword group using a result obtained by text recognition of the text recognition unit 30. Thus, the value extraction unit 32 acquires a value corresponding to each keyword.

The output unit 36 outputs an extraction result. As a result of value extraction processing, in a case where there is a keyword to which the corresponding value is not extracted, the output unit 36 causes the extraction result obtained by the value extraction unit 32 and an instruction button to be displayed in the operation display unit. The instruction button is provided for performing an instruction to add a keyword. The extraction result is a result obtained by performing value extraction processing on the designated keyword.

In the exemplary embodiment, the designated keyword is registered in the management table in advance. In a case where a value corresponding to any keyword in the associated keyword group to which the designated keyword belongs is provided, the value is set as the extraction result for the designated keyword. In a case where a plurality of values are extracted, the plurality of values are set as the extraction result. The output unit causes the user to confirm the extraction result, and receives an instruction to add a keyword from the user.

In a case of receiving the instruction to add a keyword, the keyword addition processing unit 34 acquires a keyword to be added (referred to as “an addition keyword” below) from the operation display unit. In a case where the addition keyword is associated with the registered keyword and is not registered yet, the keyword addition processing unit 34 generates a new keyword from the registered keyword and the addition keyword. The new generated keyword is referred to as “an automatically-generated keyword”.

The keyword addition processing unit 34 displays a generation result of the automatically-generated keyword in the operation display unit. The keyword addition processing unit causes the user to confirm the generation result of the automatically-generated keyword and receives a selection of the automatically-generated keyword to be registered and an instruction to determine the selection from the user.

In a case where the keyword addition processing unit receives the instruction to determine the selection, the keyword addition processing unit 34 registers the selected automatically-generated keyword in the management table. The selected automatically-generated keyword is added to the associated keyword group to which the registered keyword belongs. The keyword addition processing unit 34 displays a re-extraction screen for receiving an instruction of re-extraction in the operation display unit. The keyword addition processing unit displays the re-extraction screen and receives an instruction to perform re-extraction from the user.

In a case where the instruction to perform re-extraction is received, the value extraction unit 32 performs value extraction processing of extracting a value corresponding to the keyword, on each keyword in the associated keyword group including the automatically-generated keyword, again, so as to acquire the value corresponding to each keyword.

In a case where there is no keyword to which the corresponding value has not been extracted, and in a case where an instruction not to add a keyword is received, and an instruction to end extraction without performing re-extraction is received, the output unit 36 outputs a final result to the outside. The final result is a final result obtained by performing value extraction processing on the designated keyword.

The final result is output in a predetermined format such as a comma-separated value (CSV) file. The CSV file is a text file in which each text string representing a keyword and each text string representing a value are separated by a comma. Information of a text string representing a keyword or a value may be assigned to image information of the corresponding image as “an attribute of the image” or may be assigned to the image information of the corresponding image as “a file name”.

Value Extraction Processing

Next, a control program of value extraction processing will be described.

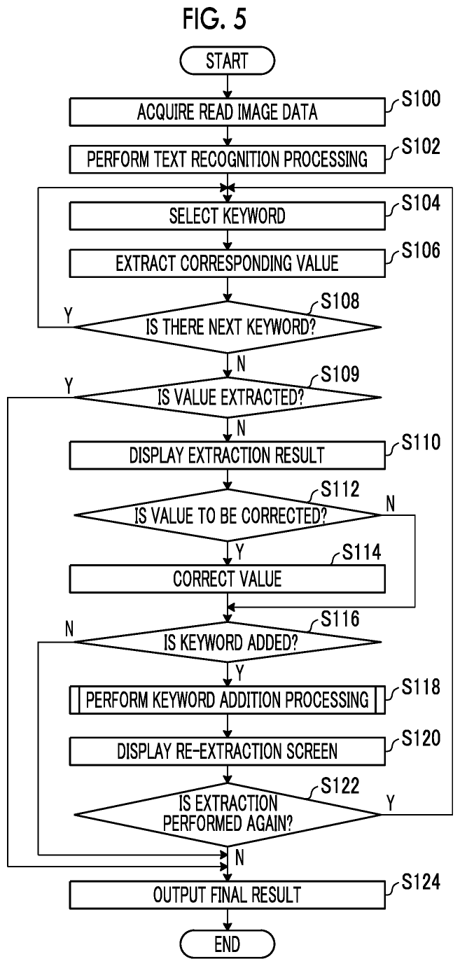

FIG. 5 is a flowchart illustrating an example of a flow of “value extraction processing”. The control program of value extraction processing is read from the storage unit 20 and is executed by the CPU 12A of the information processing apparatus 10 (see FIG. 2). In a case where an instruction to start value extraction processing is received from the user, the control program of value extraction processing is executed.

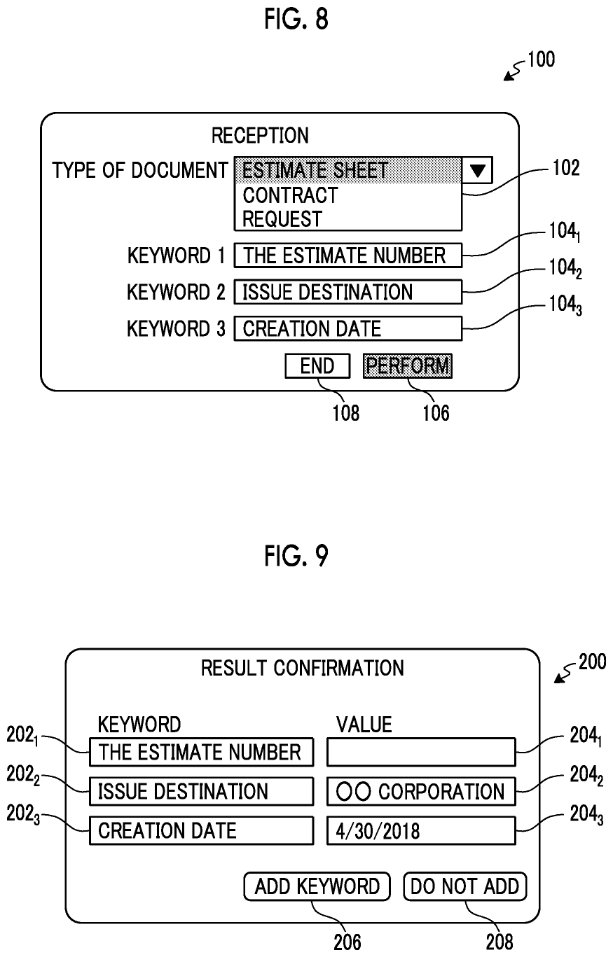

In the exemplary embodiment, the reception screen illustrated in FIG. 8 is displayed in the operation display unit 14 illustrated in FIG. 2. The reception screen is a screen for receiving designation of the type of document and each keyword, which are conditions of value extraction processing. The reception screen is operated by the user to designate the type of document and a keyword and to perform an instruction to perform value extraction processing. A plurality of keywords may be designated on the reception screen. The image reading unit 16 illustrated in FIG. 2 reads an image of an estimate sheet.

The reception screen 100 includes a selection portion 102 for selecting the type of document, input portions 1041 to 1043 for inputting keywords, a button 106 for a performing instruction, and a button 108 for an end instruction. In the example illustrated in FIG. 8, for the estimate sheet, a plurality of keywords such as “the estimate number”, “issue date”, and “creation date” are designated.

Firstly, in Step S100, image information of a read image of the estimate sheet is acquired from the image reading unit. In Step S102, text recognition processing is performed on the read image of the estimate sheet, and a text recognition result is stored.

In Step S104, one keyword is selected from an associated keyword group to which the designated keyword belongs. For example, in the example illustrated in FIG. 3, the number is assigned to each keyword in the associated keyword group, for example, Keyword 1 or Keyword 2. The assigned number represents the priority of the keyword and is selected in order from the first. In Step S106, a value corresponding to the selected keyword is extracted. The extracted value is stored in association with the designated keyword.

Then, in Step S108, it is determined whether or not there is the next keyword. In a case where there is the next keyword, the process returns to Step S104. In a case where values for all keywords in the associated keyword group are extracted, and thus the next keyword is not provided, the process proceeds to Step S109.

In Step S109, it is determined whether or not the value for each designated keyword is extracted. In a case where the value is extracted, the process proceeds to Step S124. In Step S124, the value stored in association with the designated keyword is output as a final result to the outside. Then, the routine is ended. In a case where there is a keyword to which the corresponding value is not extracted, the process proceeds to Step S110.

In Step S110, in a case where there is a keyword to which the corresponding value is not extracted, a result confirmation screen is displayed in the operation display unit. The result confirmation screen is a screen for causing the user to confirm the extraction result for the designated keyword and for receiving addition of a keyword, correction of the value, and the like.

FIG. 9 is a schematic diagram illustrating an example of the result confirmation screen. The result confirmation screen 200 includes display units 2021 to 2023 for displaying a keyword, display units 2041 to 2043 for displaying a value, a button 206 for an instruction to add a keyword, and a button 208 for an instruction not to add a keyword. Each of the display units 2041 to 2043 is displayed in a state where the value obtained as the extraction result is allowed to be corrected.

In the example illustrated in FIG. 9, a value corresponding to a keyword of “the estimate number” is not extracted. In a case where value extraction processing with a keyword is performed, a text string of a keyword included in a document is different in a case where the identical type of documents are provided, but the formats of the documents are different from each other. More values are extracted by adding a new keyword to the associated keyword group.

In Step S112, it is determined whether or not the value obtained as the extraction result is to be corrected. In a case where the value displayed on the result confirmation screen 200 is corrected, the value is corrected in Step S112. In a case where the value is to be corrected, the process proceeds to Step S114. In Step S114, the value stored in association with the designated keyword is corrected. In a case where the value is not corrected, Step S114 skips, and the process proceeds to Step S116.

Then, Step S116, it is determined whether or not an instruction to add a keyword is received. In the result confirmation screen illustrated in FIG. 9, an instruction to add a keyword is made by the button 206, and an instruction not to add a keyword is made by the button 208. In a case where the instruction to add a keyword is received, the process proceeds to Step S118. In a case where the instruction not to add a keyword is received, Steps S118 to S122 skip, and the process proceeds to Step S124.

Then, in Step S118, “keyword addition processing” is performed.

Keyword Addition Processing

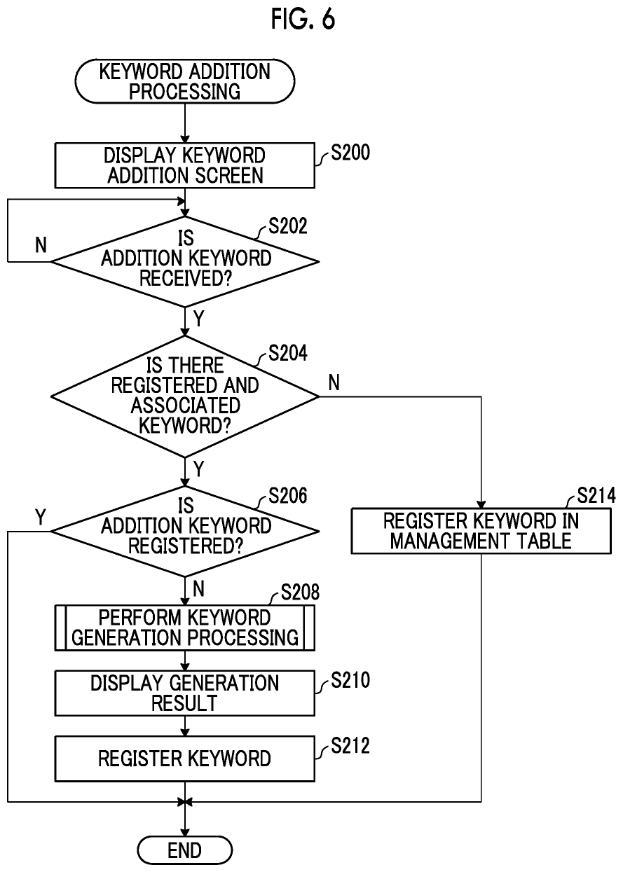

Here, “keyword addition processing” will be described. FIG. 6 is a flowchart illustrating an example of a flow of “keyword addition processing”. Firstly, in Step S200, a keyword addition screen is displayed in the operation display unit. The keyword addition screen is a screen for receiving an input of adding a keyword. In a case where a keyword is added by the user, an automatically-generated keyword is generated from the registered keyword and the addition keyword under a predetermined condition.

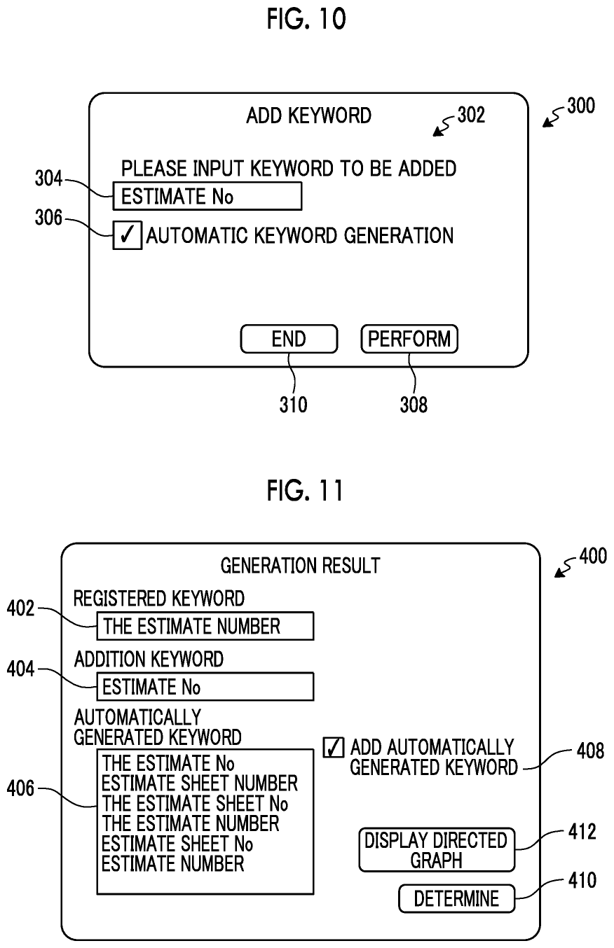

FIG. 10 is a schematic diagram illustrating an example of the keyword addition screen. The keyword addition screen 300 includes a message 302 such as “please input a keyword to be added”, an input portion 304 for inputting an addition keyword, a selection portion 306 for selecting automatic generation of a keyword, a button 308 for a performing instruction, and a button 310 for an end instruction.

In Step S202, it is determined whether or not an input of an addition keyword is received. In a case where the input of the addition keyword is received, the process proceeds to Step S204. Determination of whether or not the input of the addition keyword is received is performed until an instruction to end the input of adding a keyword is received. In a case where the input of the addition keyword is received, the process proceeds to Step S204.

Then, in Step S204, it is determined whether or not there is a registered keyword which is associated with the addition keyword. In a case where the registered keyword to be associated is provided, the process proceeds to Step S206. In a case where the registered keyword to be associated is not provided, the process proceeds to Step S214. In Step S214, the addition keyword is newly registered in the management table, and the routine is ended.

In Step S206, it is determined whether or not the addition keyword is registered. In a case where the addition keyword is not registered, the process proceeds to Step S208. In a case where the addition keyword is registered, there is no need for registration. Thus, the routine is ended.

In Step S208, “keyword generation processing” is performed. In a case where the registered keyword which is associated with the addition keyword is provided, and the addition keyword is not registered, “keyword generation processing” is performed. The keyword generation processing will be described later. In Step S210, a generation result display screen is displayed in the operation display unit. The generation result display screen is a screen for displaying a generation result of a keyword and receiving selection of a keyword as a registration target among automatically-generated keywords. In Step S212, each of the addition keyword and the selected keyword is registered in the management table, and then the routine is ended.

FIG. 11 is a schematic diagram illustrating an example of the generation result display screen. The generation result display screen 400 includes a display portion 402 for displaying a registered keyword, a display portion 404 for displaying an addition keyword, a display portion 406 for displaying an automatically-generated keyword, a button 408 for selecting addition of the automatically-generated keyword to the management table, a button 410 for determining a keyword as a registration target, and a button 412 for displaying a directed graph.

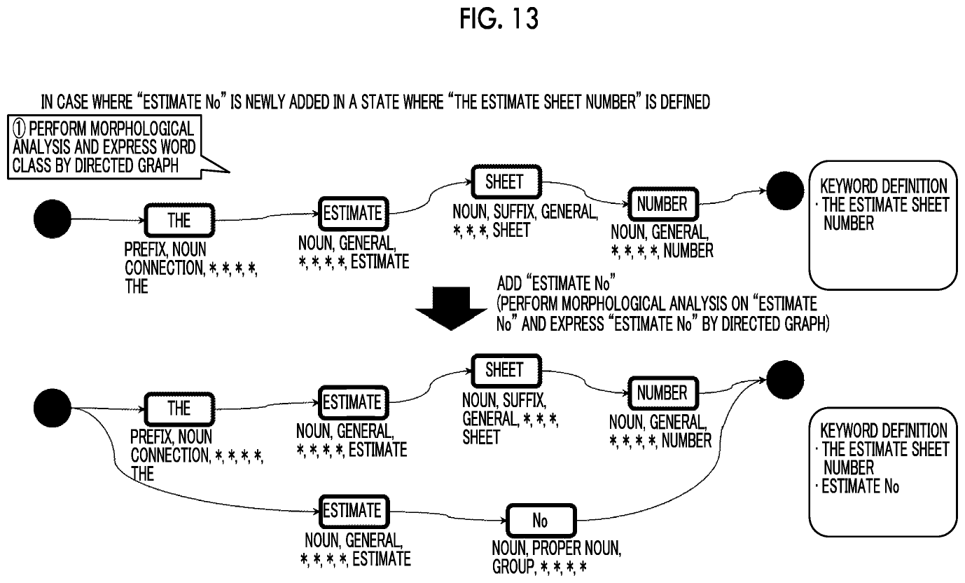

With the generation result display screen 400, the registered keyword, the addition keyword, and the automatically-generated keyword are displayed in a list. The automatically-generated keyword is displayed at the display portion 406, in a correctable state. For example, some keywords of automatically-generated keywords, such as keywords in which the word combination has a problem, may be deleted. Priorities may be assigned to a plurality of keywords. The directed graph is a graph indicating connections between a plurality of words included in the keyword. Details of the directed graph will be described later (see FIGS. 13 to 15).

Here, descriptions with reference to FIG. 5 will be made again. In Step S120, a re-extraction screen is displayed in the operation display unit. The re-extraction screen is a screen for receiving an instruction to perform re-extraction from the user. In a case where the automatically-generated keyword is added to the associated keyword group, value extraction processing may be performed again on each keyword in the associated keyword group including the automatically-generated keyword.

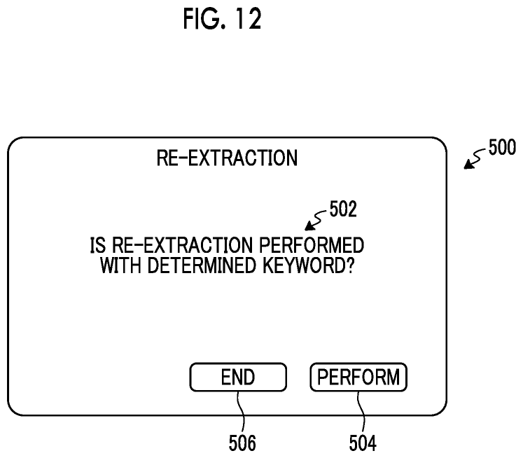

FIG. 12 is a schematic diagram illustrating an example of the re-extraction screen. The re-extraction screen 500 includes a message 502 such as “re-extraction is performed with the determined keyword?”, a button 504 for a performing instruction, and a button 506 for an end instruction.

In Step S122, it is determined whether or not an instruction to perform re-extraction is received. In a case where the instruction to perform re-extraction is received, the process proceeds to Step S104. Returning to Step S104, value extraction processing is performed again for each keyword in the associated keyword group including the automatically-generated keyword. In a case of receiving an instruction to end extraction, the process proceeds to Step S124.

Then, in Step S124, the value stored in association with the designated keyword is output as the final result to the outside, and the routine is ended.

Keyword Generation Processing

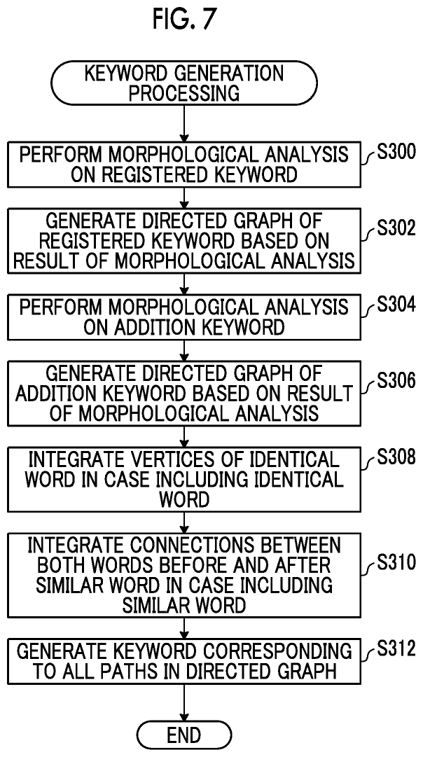

Here, “keyword generation processing” will be described. FIG. 7 is a flowchart illustrating an example of a flow of “keyword generation processing”. FIGS. 13 to 15 are diagrams illustrating a form in which directed graphs representing keywords are integrated. In this example, “the estimate sheet number” is registered in advance in the management table, as the registered keyword. “Estimate No” is added as the addition keyword, but is not registered.

Firstly, in Step S300, morphological analysis is performed on the registered keyword. The morphological analysis is a process of dividing a text string in a morpheme unit being the smallest meaningful unit by using a dictionary data or the like, and determining and assigning a word class, utilization, reading, and the like of each morpheme.

A morpheme is a unit that cannot be divided any more. Strictly, the morpheme is finer than a word, for example, division of “estimate sheet” into “estimate” and “sheet”. In the exemplary embodiment, “a word” is set to be synonymous with morpheme. The word class is a type by which words are classified. With the morphological analysis, a first word group is acquired from the registered keyword.

In the example illustrated in FIG. 13, “the estimate sheet number” being the registered keyword is divided into “the”, “estimate”, “sheet”, and “number”. The words are recognized as “the” (prefix, noun connection, “the”), “estimate” (noun, general, estimate), “sheet” (noun, suffix, general, *, *, *, sheet), “number” (noun, general, *, *, *, *, number).

Then, in Step S302, a directed graph of the registered keyword is generated based on a result of the morphological analysis. The directed graph is a graph composed of vertices and sides (arrows) having a direction. The vertex includes a start point and an end point. The vertex other than the start point and end point is labeled with a word acquired by the morphological analysis.

Vertices representing words included in the keyword are connected in order of description from the side. The vertex representing the leading word is connected to the start point. The vertex representing the last word is connected to the end point. The vertices representing the words of the registered keyword are connected in order of “start point→“the”→“estimate”→“sheet”→“number”→end point”.

In Step S304, the morphological analysis is performed on the addition keyword. With the morphological analysis, a second word group is acquired from the addition keyword. In the example illustrated in FIG. 13, “estimate No” being the addition keyword is divided into “estimate” and “No”. The words are recognized as “estimate” (noun, general, estimate) and “No” (noun, proper noun, group, *, *, *, *).

Then, in Step S306, a directed graph of the addition keyword is generated based on a result of the morphological analysis. The vertices representing the words of the addition keyword are connected in order of “start point→“estimate”→“No”→end point”.

The directed graph of the registered keyword and the directed graph of the addition keyword are connected with each other with the start point and the endpoint as common vertices. In the connected directed graph, there are a first path and a second path to reach the endpoint from the start point. The first path indicates “start point→“the”→“estimate”→“sheet”→“number”→end point”. The second path indicates “start point→“estimate”→“No”→end point”.

In Step S308, in a case where the registered keyword and the addition keyword include the identical word, the vertices of the identical word are integrated.

Each word which has been acquired from the addition keyword and is included in the second word group is compared to each word which has been acquired from the registered keyword and is included in the first word group, and thus the identical word is detected. Here, a criterion for determining whether or not the words are the identical is predetermined.

In the exemplary embodiment, in addition to words having the identical notation, words having the identical notation except for fluctuations in the notation, such as “estimate” and “estimation”, are also determined to be the identical word.

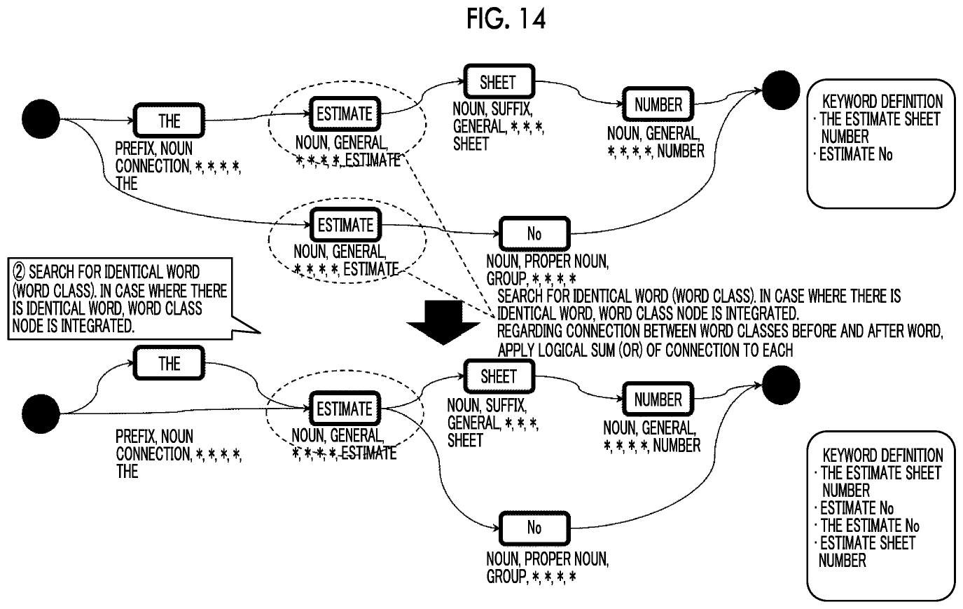

As illustrated in FIG. 14, “estimate No” being the addition keyword includes the identical word “estimate” as “estimate” of the registered keyword. The vertex of “estimate” of the registered keyword and the vertex of “estimate” of the addition keyword are integrated. A third path indicating “start point→“the”→“estimate”→“No”→end point” and a fourth path indicating “start point→“estimate”→“sheet”→“number”→end point” are added to the first path and the second path.

In Step S310, in a case where the registered keyword and the addition keyword include the similar word, connections between words before and after the similar word are integrated.

Each word which has been acquired from the addition keyword and is included in the second word group is compared to each word which has been acquired from the registered keyword and is included in the first word group, and thus the similar word is detected. Here, a criterion for determining whether or not the words are similar to each other is predetermined. For example, whether or not the words are similar is determined using a thesaurus. The thesaurus is a synonym dictionary that classifies and organizes words according to upper/lower relations, partial/whole relations, synonym relations, and the like.

In the exemplary embodiment, in a case of words having different notations and the identical meaning, such as “number” and “No”, it is determined that the words are similar words.

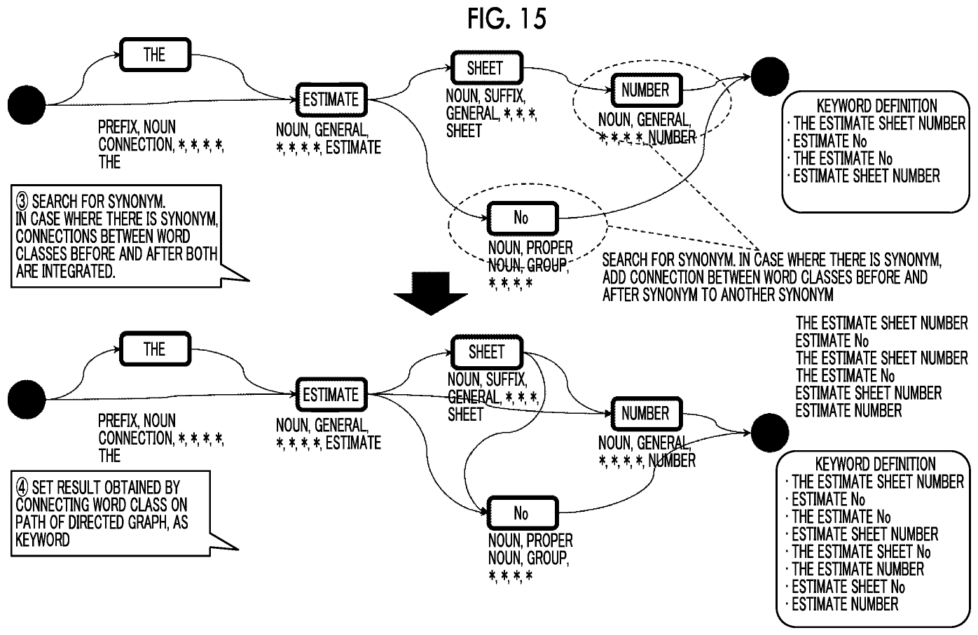

As illustrated in FIG. 15, “estimate No” being the addition keyword includes the word “number” similar to “No” of the registered keyword. A side for connecting the vertex of “number” of the registered keyword to the vertex of “estimate” that connects the front side of the vertex of “No” of the addition keyword is added. A side for connecting the vertex of “No” of the addition keyword to the vertex of “sheet” that connects the front side of the vertex of “number” of the registered keyword is added.

A fifth path indicating “start point→“the”→“estimate”→“sheet”→“No”→end point”, a sixth path indicating “start point→“estimate”→“sheet”→“No”→end point”, a seventh path indicating “start point→“the”→“estimate” “number” end point”, and an eighth path indicating “start point “estimate” “number” end point” are added to the paths from the first path to the fourth path.

In the example illustrated in FIG. 15, the end point is provided on the rear side of the vertex of “number” and the vertex of “No”. In a case where a vertex is provided on the rear side of the vertex of “number” and the vertex of “No”, the vertex of “number” of the registered keyword is connected to a vertex of “first rear side” connected to the rear side of the vertex of “No” of the addition keyword. The vertex of “No” of the addition keyword is connected to a vertex of “second rear side” connected to the rear side of the vertex of “number” of the registered keyword.

Then, in Step S312, keywords corresponding to all paths in the directed graph are generated, and the routine is ended. Since the vertices of the directed graph are integrated, and the side is added, a new path connecting the start point and the end point is added, and thus a new keyword is generated. The new keyword is represented by the path in the directed graph. Thus, the directed graph illustrated in FIG. 15 may be displayed as the generation result of the automatically-generated keyword. For example, in a case where the button 412 is pressed on the generation result display screen 400 illustrated in FIG. 11, the directed graph illustrated in FIG. 15 is displayed.

In the above example, the new keyword is represented by the path in the directed graph. However, even though the directed graph is not generated, the new keyword is generated in accordance with rules as follows.

(1) Reference Word

“The identical word and the similar word” included in each of the first word group acquired from the addition keyword and the second word group acquired from the registered keyword are detected as a pair of reference words which serve as a criterion of combination.

(2) Combination Target

A combination target is set to at least one of a first target word which is connected before or after the reference word and serves as a combination target in the first word group, or a second target word which is connected before or after the reference word and serves as a combination target in the second word group.

(3) Combination of Front and Rear Words

The reference word and at least one of the first target word or the second target word are combined while maintaining a context with the reference word. Here, some words having a word class which is, for example, a prefix or a suffix may be omitted or added.

### Modification Examples

The configurations of the information processing apparatus, an information processing system, and the program described in the exemplary embodiment are just an example. The configurations may be changed in a range without departing from the gist of the invention.

In the exemplary embodiment, a case where the value extraction processing is implemented by software is described. However, the equivalent processing may be implemented by hardware.

In the exemplary embodiment, an example in which the automatically-generated keyword is displayed in the operation display unit and is output is described. However, the automatically-generated keyword may be registered in the management table without displaying the automatically-generated keyword for the user.

In the exemplary embodiment, an example in which the designated keyword is the registered keyword, and a new keyword is automatically generated from the registered keyword and the addition keyword to be added is described. However, the new keyword may be automatically generated from a plurality of designated keywords. For example, in a case where the plurality of designated keywords are not registered yet, the new keyword may be automatically generated from the plurality of designated keywords, and the designated keywords and the automatically-generated keyword may be registered.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing apparatus comprising:
a storage unit that stores a first keyword obtained by combining a plurality of words;
an extraction unit that extracts a text string indicating a value corresponding to the first keyword, from a result of text recognition on a document image;
a detection unit that detects an identical or similar word, as a reference word being a reference of a combination, from a plurality of words included in the first keyword and a second keyword in response to reception of an instruction to newly register the second keyword having a meaning which is not identical but similar to a meaning of the first keyword; and
an output unit that outputs a new third keyword obtained by combining the reference word and at least one of a first target word or a second target word while maintaining a context with the reference word, the first target word being connected before or after the reference word in the first keyword, and being a target of a combination, the second target word being connected before or after the second keyword, and being a target of the combination.

2. The information processing apparatus according to claim 1,
wherein the detection unit detects the identical or similar word based on a result of morphological analysis on the first keyword and a result of morphological analysis on the second keyword, and
the output unit outputs the third keyword based on the result of the morphological analysis on the first keyword and the result of morphological analysis on the second keyword.

3. The information processing apparatus according to claim 1,
wherein the identical or similar word refers to any one of a word having the identical notation, a word having the identical notation except that there is fluctuation, and a word which has a different notation and the identical meaning.

4. The information processing apparatus according to claim 2,
wherein the identical or similar word refers to any one of a word having the identical notation, a word having the identical notation except for a small difference, and a word which has a different notation and the identical meaning.

5. The information processing apparatus according to claim 1,
wherein a word as a prefix or a suffix is added to at least one of the first target word or the second target word or is deleted from at least one of the first target word or the second target word.

6. The information processing apparatus according to claim 2,
wherein a word as a prefix or a suffix is added to at least one of the first target word or the second target word or is deleted from at least one of the first target word or the second target word.

7. The information processing apparatus according to claim 3,
wherein a word as a prefix or a suffix is added to at least one of the first target word or the second target word or is deleted from at least one of the first target word and the second target word.

8. The information processing apparatus according to claim 4,
wherein a word as a prefix or a suffix is added to at least one of the first target word or the second target word or is deleted from at least one of the first target word or the second target word.

9. The information processing apparatus according to claim 1, further comprising:
a display unit that displays the outputted third keyword to be selectable and receives a selection by a user.

10. The information processing apparatus according to claim 2, further comprising:
a display unit that displays the outputted third keyword to be selectable and receives a selection by a user.

11. The information processing apparatus according to claim 3, further comprising:
a display unit that displays the outputted third keyword to be selectable and receives a selection by a user.

12. The information processing apparatus according to claim 4, further comprising:
a display unit that displays the outputted third keyword to be selectable and receives a selection by a user.

13. The information processing apparatus according to claim 5, further comprising:
a display unit that displays the outputted third keyword to be selectable and receives a selection by a user.

14. The information processing apparatus according to claim 6, further comprising:
a display unit that displays the outputted third keyword to be selectable and receives a selection by a user.

15. The information processing apparatus according to claim 9,
wherein the third keyword selected in the display unit is controlled to be stored in the storage unit.

16. The information processing apparatus according to claim 15,
wherein the display unit displays the third keyword in a form of a directed graph.

17. The information processing apparatus according to claim 15,
wherein the display unit further displays a reception screen for receiving an extraction result by the extraction unit and the second keyword.

18. The information processing apparatus according to claim 17,
wherein, in a case where a text string indicating a value corresponding to the first keyword is not extracted by the extraction unit, the display unit displays the reception screen.

19. The information processing apparatus according to claim 1,
wherein the storage unit stores the second keyword and the third keyword as an associated keyword group to which the first keyword belongs.

20. A non-transitory computer readable medium storing a program causing a computer to function as:
the units of the information processing apparatus according to claim 1.
